(19) United States
(12) Patent Application Publication
(10) Pub. No.: US 2014/0349598 A1
(43) Pub. Date: Nov. 27, 2014

(54) Signal Carrier Modulation Using a Polarization Switchable Antenna

(71) Applicants: Leonard De La Cruz, Hollywood, MD (US); Saad Tabet, Lusby, MD (US)

(72) Inventors: Leonard De La Cruz, Hollywood, MD (US); Saad Tabet, Lusby, MD (US)

(73) Assignee: United States of America as represented by the Secretary of the Navy, Patuxent River, MD (US)

(21) Appl. No.: 13/899,010

(22) Filed: May 21, 2013

(51) Int. Cl. H04B 7/10; H01Q 9/04; H01Q 21/24

(52) U.S. Cl. CPC H04B 7/10; H01Q 21/245; H01Q 9/0428
USPC 455/110

(57) ABSTRACT

A system for modulating a communications signal using a switchable antenna. By using a polarization switchable antenna, modulation of a signal and/or carrier can be achieved by switching the polarization of antenna. Since the change of polarization is achieved by separate circuitry, the signal or message can be modulated by other methods and be modulated again by antenna.

### STATEMENT OF GOVERNMENT INTEREST

The invention described herein may be manufactured and used by or for the Government of the United States of America for governmental purposes without payment of any royalties thereon or therefore.

### BACKGROUND

In all telecommunication networks, data is transmitted through a process called modulation. This is the process of mixing or packing data values within carrier signals simply by varying any intrinsic feature (amplitude, frequency, pulse rate, pulse width, or phase) of carrier signal according to the variations present within the data signal. Modulation protects data values so they can travel long distances over communication networks in the form of digital packets or wave envelopes. Upon reaching their destination, these data values are separated from carrier signals. This process is termed demodulation.

Modulation can be accomplished in a variety of ways depending on the tradeoff one is willing to accept. Simple hardware can be used in transmitters and receivers to communicate information. However, this uses a lot of spectrum which limits the number of users. Alternatively, more complex transmitters and receivers can be used to transmit the same information over less bandwidth. The transition to more and more spectrally efficient transmission techniques requires more and more complex hardware. Complex hardware is difficult to design, test, and build. This tradeoff exists whether communication is over air, wire, analog or digital.

Over the years, a major transition has occurred from simple analog Amplitude Modulation (AM) and Frequency/Phase Modulation (FM/PM) to new digital modulation techniques. Examples of digital modulation include QPSK (Quadrature Phase Shift Keying), FSK (Frequency Shift Keying), MSK (Minimum Shift Keying), and QAM (Quadrature Amplitude Modulation). Another layer of complexity in many new systems is multiplexing. Two principal types of multiplexing (or “multiple access”) are TDMA (Time Division Multiple Access) and CDMA (Code Division Multiple Access). These are two different ways to add diversity to signals allowing different signals to be separated from one another. These types of modulation techniques are accomplished with a combination of hardware and software coding. Altering the modulation scheme typically requires re-coding the software which can be expensive. This is especially problematic for applications that need to be cost effective and accurate such as global positioning systems (GPS).

Therefore, what is needed is a cost effective way for modulating a signal without using expensive hardware and software that has to be regularly upgraded.

### SUMMARY

A novel system for modulating a signal using a polarization switchable antenna is disclosed. The system comprises a communications signal transmitter and a polarization switchable antenna. The modulation of the communications signal is achieved by switching the polarization of the antenna. In one embodiment of the system, the polarization switchable antenna is a single fed dual band circularly polarized patch antenna with upper and lower antenna elements. The upper and lower antenna elements are connected by switchable electronic devices that are arranged so that the left-hand circular polarization and right-hand circular polarization of the antenna can be achieved by activating and deactivating combinations of the switchable electronic devices based on whether a logic zero or a logic one is applied.

In another embodiment, the modulation system further comprises a polarization detector for demodulating the signal. The polarization detector demodulates the signal by measuring the phase between signals. The relative phase between signals dictates whether the signal is a right-hand circular or left-hand circular polarized signal.

### DRAWINGS

The features, aspects, and advantages of the present invention are shown with reference to the following description, appended claims, and accompanying drawings wherein:

FIG. 1 is a block diagram of a prior art signal modulation system;

FIG. 2 is a block diagram of a first embodiment of the present signal modulation system.

FIG. 3 is a planar view of a polarization switchable patch antenna showing electronic switches separating the antenna elements.

FIG. 4 is a planar view of the polarization antenna showing its internal structure.

FIG. 5 is another embodiment of the modulation system using a signal modulator in conjunction with a polarization switchable antenna.

FIG. 6 is a diagram of an alternate embodiment of the present signal modulation system with a polarization switchable antenna and a demodulating antenna.

### DESCRIPTION

In the following description of the present invention, reference will be made to various embodiments which are not meant to be all inclusive. The current invention can be implemented using a variety of hardware including various polarization switchable antennas, polarization detectors and software.

Probe fed patch antennas come in many shapes and sizes. The most commonly used shapes are circular, rectangular and square. Patch antennas are inherently narrow banded in their performance and they normally require a dielectric layer between them and their back plane to keep their size and weight reasonable.

One of the most common areas of use for patch antennas is in the Global Positioning Systems (GPS) area. GPS is a space-based satellite navigation system that provides location and time information on or near the Earth where there is a sight line to GPS satellites. GPS systems provide navigation capabilities to military, civil and commercial users around the world and are accessible to anyone with a GPS receiver.

Patch antennas provide reasonable gain, an upper hemispherical “mushroom” radiation pattern, a narrow band of operation, high manufacturing repeatability, and a low profile. They also can be easily made to radiate (or receive) right-hand circular polarization (RHCP). These features lend themselves well for use as receiving antennas of GPS signals. Since the L2 (military) and L1 (commercial) GPS bands are normally quite narrow (−24 MHz), the patch antenna can be designed to reject adjacent frequencies that are outside the bandwidth of interest. This is a highly desirable feature since GPS signals received from satellites normally posses very low power (<−120 dBm), which makes them quite vulnerable to interference.

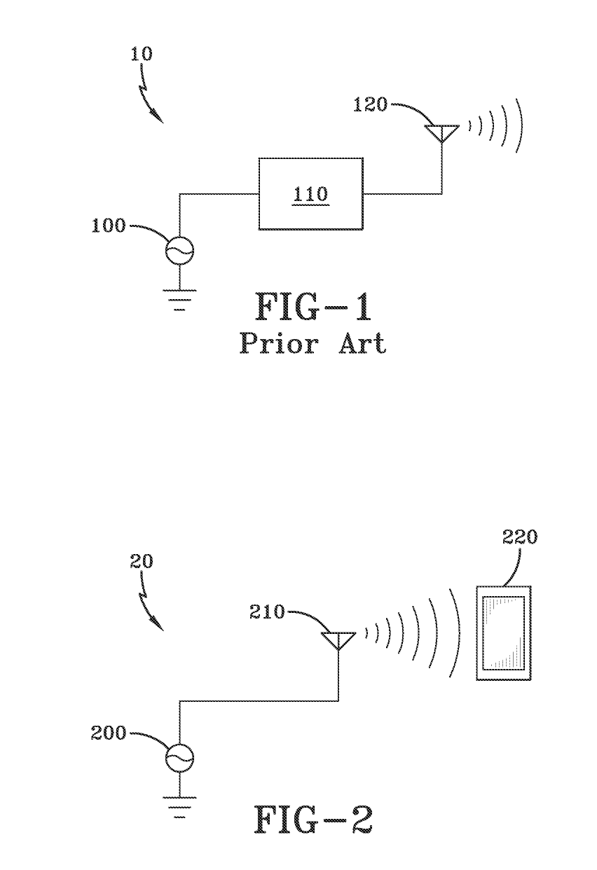

Typically, in antenna systems, signal modulation is conducted with a combination of hardware and software at some point prior to the signal reaching the antenna. FIG. 1 shows a typical antenna system (10) were the signal is varied by a modulator (110) situated between the signal transmitter (100) and the antenna (120). Enhancements or changes to the modulator (110) may require significant time and money because the software and/or hardware require upgrades. The current invention not only remedies this problem, but also provides an alternative that allows for enhanced security and greater signal capacity.

FIG. 2 shows an embodiment of the current invention. FIG. 2 shows a communications system 20 with the signal modulator replaced with a patch antenna. In this communications system (20), the signal is modulated by changing the polarization of the patch antenna (210) back and forth between-right hand circular and left-hand circular polarization with the application of a logic one or a logic zero.

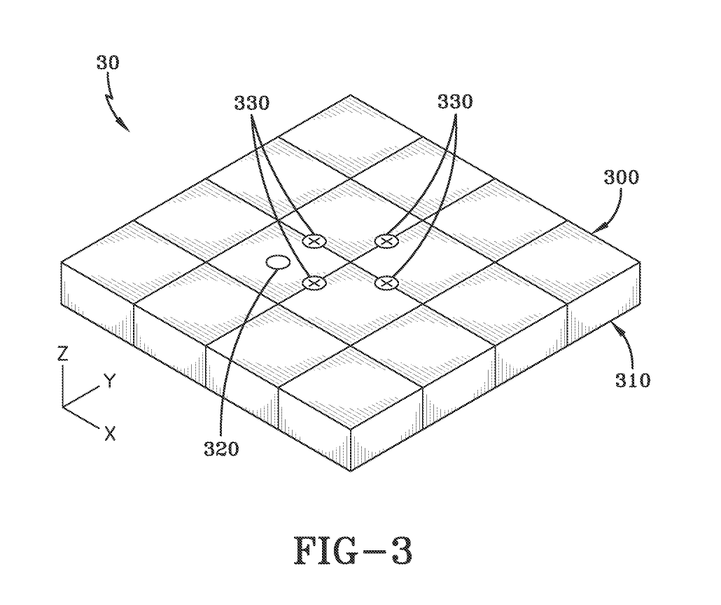

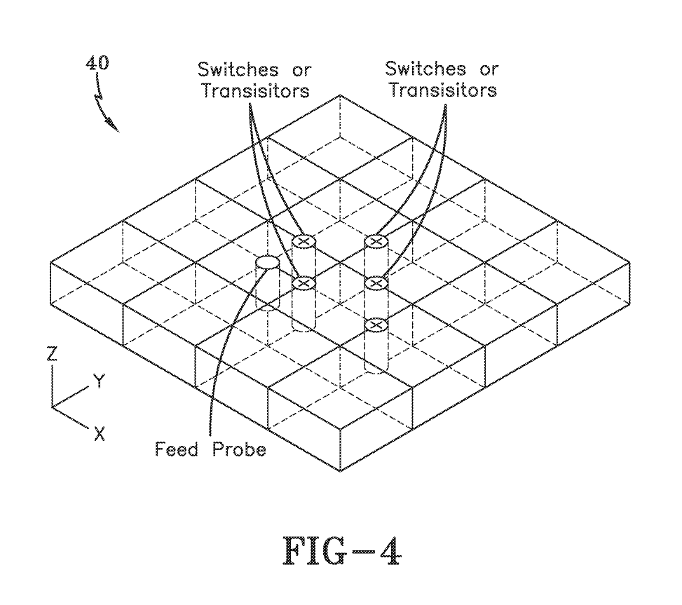

FIG. 3 shows a planar view of polarization switchable patch antenna (30), which has coplanar antenna elements (300 and 310) and an electrical feed probe (320) connected to the first antenna element (300). The antenna elements (300) and (310) are electrically connected by fast responding switches (330). The switches can be transistors, shunts, diodes or any other switchable electronic device. The patch antenna is designed according to best practices with regard to dielectric substrate choices, patch height and width, dielectric thickness etc. to achieve the desired gain. FIG. 4 is an internal planar view of the patch antenna, showing switches connecting the antenna elements.

The electronic switches can be placed in different locations and in various numbers between the patch antenna elements to modulate the signal. Then, different combinations of the switches are activated to create different polarizations, which can, in turn, be used to modulate the signal, depending on whether a logic one or logic zero is applied to the signal. Typically, parallel switches are activated simultaneously to achieve the desired polarization. Patch antennas are actually capable of all 4 polarizations (i.e. quad polarization, switchable antenna): right-hand circular, left-hand circular, vertical and horizontal, based on the placement of the switches.

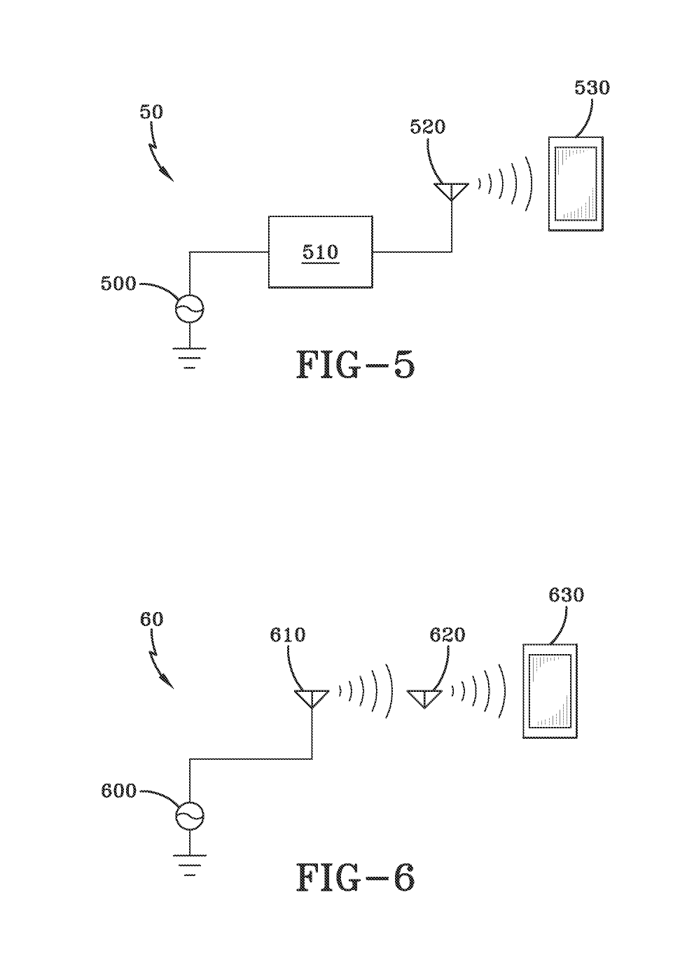

FIG. 5 shows another embodiment of the antenna modulation system (50) with an antenna 520 used in conjunction with a modulator (510). In this configuration, the communications signal that is emitted from a source (500) can be modulated twice. First, the signal is modulated by modulator (510) using known techniques such as AM, FM, QPSK modulation, etc. Then the signal is modulated again by an antenna (520) of the present invention, by switching the polarization as previously described. This dual modulation provides several advantages. Most communications carriers use only one frequency to send messages. A given frequency has a limited bandwidth and can only accommodate a certain amount of data. This limits the amount of data that can be sent in any given communications system, which also diminishes security because only a limited amount of encryption can be used when sending data. With this dual modulation configuration, additional data can be sent along with previously modulated data, whether it is an extra layer of security coding or some other informative data. Either way, potentially twice a much data can be sent with this configuration.

At the receiving end of the modulation system, data can be recovered using a polarization detector. For instance, a cross dipole antenna can be used to receive the theta and phi components of the electric field separately. This configuration (60) is shown in FIG. 6. FIG. 6 shows a polarization switchable antenna in communication with a cross dipole antenna. One can measure the phase between E_theta and E_phi to determine the directional polarization of the antenna. If the phase is +90 degrees with respect to E_theta, the polarization is right-hand circularly polarized. Otherwise, it is left-hand circularly polarized. Since neither of the dipole measurements, E_theta nor E_phi, are known, one can simply add +90 degrees to one of the signals. If the resultant phase is +180, the polarization is right-hand circular. If the resultant phase is 0 degrees, the polarization is left-hand circular. This will inform the signal recipient whether a logic zero or a logic one was sent.

Although the invention has been described in detail with particular reference to preferred embodiments, other embodiments can achieve the same results. Variations and modifications of the present invention will be obvious to those skilled in the art and it is intended to cover, in the appended claims, all such modification and equivalents. The entire disclosure and all references, applications, patents and publications cited above are herby incorporated by reference.

What is claimed is:

1. A system for modulating a communications signal, comprising:
a communications signal transmitter; and
a polarization switchable antenna to receive and modulate the communications signal, wherein the communications signal is modulated by switching the polarization of the polarization switchable antenna.

2. The system of claim 1, wherein the polarization switchable antenna is a dual band circularly polarized patch antenna.

3. The system of claim 2, wherein the polarization switchable antenna further comprises.
an upper antenna element; and
a lower antenna element.

4. The system of claim 3, wherein the upper and lower antenna elements are connected by switchable electronic devices.

5. The system of claim 4, wherein the switchable electronic devices are arranged so that activating and deactivating combinations of the switchable electronic devices creates left-hand circular polarization and right-hand circular polarization.

6. The system of claim 5, wherein the polarization switchable antenna modulates the communications signal by switching the antenna back and forth between left-hand circular polarization and right-hand circular polarization.

7. The system of claim 6, wherein the polarization switchable antenna switches between left-hand circular polarization and right-hand circular polarization when a logic zero or a logic one is applied to combinations of the switchable electronic devices.

8. A system for transmitting a signal, comprising:
a signal transmitter;
a polarization switchable patch antenna for receiving and modulating the signal; and
a polarization detector for receiving and demodulating the modulated signal.

9. The system of claim 8, wherein the polarization of the switchable patch antenna is switched between right-hand circular polarization and left-hand circular polarization to modulate the signal.

10. The system of claim 8, wherein signal demodulation is achieved by measuring the phase of the signal with the polarization detector.

11. The system of claim 8, wherein the switchable patch antenna further comprises:
an upper antenna element; and
a lower antenna element.

12. The system of claim 11, wherein the upper antenna element and lower antenna element are connected by switchable electronic devices.

13. The system of claim 12, wherein the switchable electronic devices are arranged so that activating and deactivating combinations of the switchable electronic devices creates left-hand circular polarization and right-hand circular polarization.

14. The system of claim 13, wherein the switchable patch antenna switches from left-hand circular polarization to right-hand circular polarization based on whether a logic zero or a logic one is applied to the switchable electronic devices.

15. A method for modulating a communications signal comprising:
receiving the communications signal with dual band circularly polarized patch antenna patch antenna with upper and lower antenna elements separated by electronic switching elements;
switching the polarization of the signal with the dual band circularly polarized patch antenna; and
transmitting the polarization switched signal.

16. The method of claim 15, wherein switching the polarization of the signal comprises applying either a logic one or logic zero to combinations of the electronic switching devices on the polarization switchable antenna.
